(19) United States
(12) Patent Application Publication
(10) Pub. No.: US 2024/0377195 A1
(43) Pub. Date: Nov. 14, 2024

(54) Level system with illumination elements for visual movement cues

(71) Applicant: Reekon Tools Inc., East Boston, MA (US)

(72) Inventors: Konstantinos Oikonomopoulos, Boston, MA (US); Colton Black, Westford, MA (US); Dennis Rogers, Somerville, MA (US); Christian Reed, Chelsea, MA (US); Yoav Reches, Cambridge, MA (US)

(21) Appl. No.: 18/659,908

(22) Filed: May 9, 2024

Related U.S. Application Data
(60) Provisional application No. 63/465,031, filed on May 9, 2023.

(51) Int. Cl. G01C 9/06; F21L 4/02; F21V 33/00; F21Y 107/40; F21Y 115/10; G01C 9/04; H05B 45/10; H05B 45/20; H05B 47/105; H05B 47/155

(52) U.S. Cl. CPC G01C 9/06; F21L 4/02; F21V 33/0084; G01C 9/04; H05B 45/10; H05B 45/20; H05B 47/105; H05B 47/155; F21Y 2107/40; F21Y 2115/10; G01C 2009/066

(57) ABSTRACT

A level system comprises a level module, and at least one level extrusion comprising a structural arrangement configured to independently receive and retain the level module. The level module comprises a sensor, a display, and control elements configured to provide level indications on the display based on data collected by the sensor. The level extrusion has a set of one or more illumination elements, e.g., positioned in an endcap, to provide visual cues to a user regarding movement direction.

### BACKGROUND OF THE INVENTION

This disclosure relates generally to leveling devices and methods.

Levels are an elemental tool for layout and ensuring items are level with respect to the ground or desired angle relative to a surface. Traditionally, levels contain a bubble in a vial of liquid which, along with markings on the vial, indicate to the user when something is level. This bubble-based technology, however, is outdated and can be hard to see, and it does not allow much granularity beyond level/not level. While a digital level offers some improvements over the analog level, the cost of such devices is prohibitive, especially as levels often come in a variety of lengths, and it is not cost-effective to replace multiple analog levels with multiple digital versions.

### SUMMARY OF THE INVENTION

This disclosure provides for an improved level system. In this approach, a set of lighting elements are configured within a level, typically in one or more end caps of the device. The lighting elements (e.g., LEDs, LED strips, LED modules, individual bulb, or the like) are selectively controlled to provide cues to the user about an orientation (or other positioning) of the level. For example, the set of lights are used to indicate to the user which direction a level needs to be moved in order to target a certain level. The nature of the lighting cues may vary, e.g., color transitions, lighting strobe frequencies, or other configurations can indicate to a user which direction, in multiple axes, or which way a user needs to move, to obtain a desired reading (position or orientation).

The foregoing has outlined some of the more pertinent features of the subject matter. These features should be construed to be merely illustrative. Many other beneficial results can be attained by applying the disclosed subject matter in a different manner or by modifying the subject matter as will be described.

### BRIEF DESCRIPTION OF DRAWINGS

FIG. 1 depicts the level system of this disclosure comprising a set of level extrusions, together with a level module that is configured to be selectively positioned into and retained within each of the extrusions;

FIG. 2 depicts a representative embodiment of the level module of the level system;

FIG. 3 depicts a pair of sensors in the level module;

FIG. 4 depicts the level module about to be positioned and retained in one of the level extrusions;

FIG. 5 depicts the combined assembly after the level module of FIG. 4 has been positioned within the mounting feature of the level extrusion;

FIG. 6 depicts locating features of the level module that facilitate the coupling of the module to the level extrusion;

FIG. 7 depicts how differences in the orientation/position of the level module within the level extrusion can be detected and addressed;

FIG. 8 depicts a level extrusion configured with an endcap that supports one or more illumination elements that provide visual cues to the user;

FIG. 9 depicts that the endcap may be removable;

FIG. 10 depicts how the level illumination elements provide visual cues to the user to facilitate use of the device; and

FIG. 11 depicts how the visual cues provided by the illumination elements can be correlated to the level readings provided by the level module.

### DETAILED DESCRIPTION OF THE INVENTION

### Modular Level

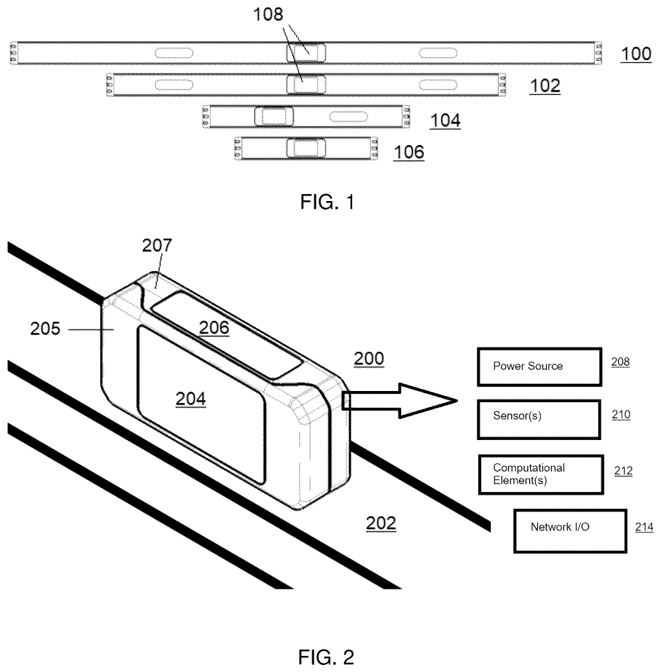

FIG. 1 depicts the level system of this disclosure comprising a set of level extrusions 100, 102, 104 and 106, together with a level module 108 that is configured to be removably received and retained within a given one of the level extrusions. Typically, a level extrusion does not include its own electronics and display(s). An extrusion 100, 102, 104 and 106 may be formed of any suitable materials including, without limitation, a metal such as aluminum or steel, a plastic material such as PVC, ABS, ABS-PC, PMMA, PC, PA, POM, and PP, and the like.

FIG. 2 depicts the level module 200 of the system, sitting on top of a given surface 202. Here, the level module 200 operates independently, although in the usual case the level module is configured within one of the level extrusions as noted. Preferably, the level module 200 includes at least two (2) distinct displays 204 and 206. A typical display is an LCD (liquid crystal) or LED (light emitting diode) display. Display 204 is located on the respective front face 205, and display 206 is located on the top face 207. Inclusion of these orthogonally-positioned displays increases visibility from multiple viewpoints. Although this placement is preferred, it is not intended to be limiting, as a single display may also be used and positioned within the level housing on any one of the exposed and outwardly-facing surfaces. The level module 200 comprises the one or more display screens, a power source (typically a battery) 208, one or more sensors 210, and a set of computational elements 212 that receive information from the one or more sensors and convert the information into level readings that are rendered on the display screens. The sensors comprise one or more inertial measurement devices, such as rotary motion sensors, accelerometers, or the like. Typical computational elements include software (computer program code) executing on one or more hardware processors, in firmware, or via other controllers. In one embodiment, the functionality of the device is enabled by a computational elements such as a microcontroller that comprises commodity hardware and software, storage and memory (RAM, ROM, and the like), as well as one or more network interfaces 214 to connect the level module to a network (e.g., a wireless or WiFi network).

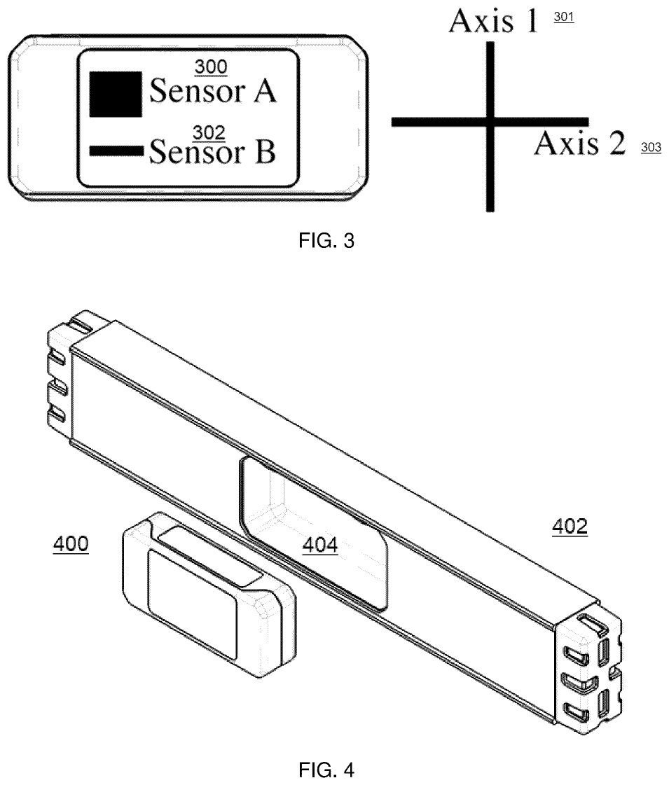

FIG. 3 depicts the level module with a pair of sensors 300 and 302, e.g., rotary motion sensors, an accelerometer, a mercury switch, or the like. The sensors are provided to enable the level module to detect angular rotation along a pair of orthogonal axes 301 and 303 as depicted. This configuration enables the level module to indicate an orientation of the module against all principal rotations (x, y and z) with respect to gravity. As such, this arrangement enables the determination of a “plumb” (a line pointing along the direction of gravity) in addition to determining a common level application, which is the determination of “level” (a line pointing perpendicular to the direction of gravity). It is not required that the level module include more than one sensor, athough typically the module will always include a sensor (e.g. a capacitive level sensor or the like) to sense the level.

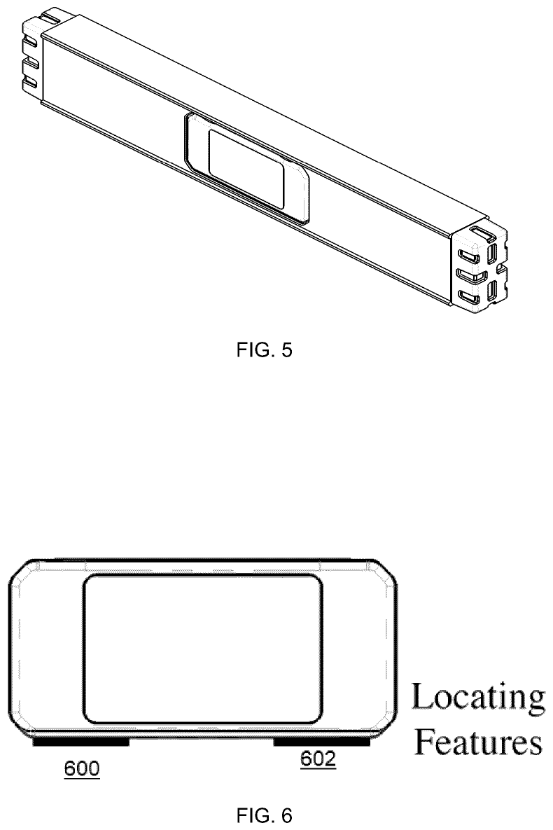

FIGS. 4 and 5 depicts how the level module is configured to be removably and interchangeably received within a level extrusion. To this end, preferably the level module couples to a level extrusion by mechanical action, by using magnets, or by using discrete fittings that capture that module within an opening in the level extrusion. As shown, FIG. 4 depicts the level module 400, and one of the level extrusions 402, for this type of arrangement. In this example and non-limiting embodiment, the level extrusion comprises a structural mounting feature 404 to locate and hold the level module. The feature 404 is an opening in the level extrusion that substantially matches the size and configuration of the level module such that the level module can be press-fit and retained securely with the extrusion. This structural arrangement ensures that the level module is completely fixed (against movement) relative to the level extrusion, as any such movement would have the potential to impair the accuracy of the level reading. FIG. 5 depicts the combined assembly after the level module has been positioned within the mounting feature. In this embodiment, there may be a display located on each opposed face of the level module (back and front), and the opening within the level extrusion is all the way through the extrusion such that the level reading is available from both the front and back sides.

To facilitate the positioning and retaining of the level module within the level extrusion, preferably the level module includes one or more locating features, such as depicted in FIG. 6. In this embodiment, the locating features 600 and 602 comprise a pair of mechanical structures, such as tabs, flanges, projections, or the like. The geometry of the locating features may vary, but generally these features facilitate the orienting of the level module within the extrusion as well as the positive locking of the module. There may be multiple such features positioned about the outer surface of the level module. While some of these features are used to facilitate coupling of the module within the level extrusion, others may be used for alignment to ensure that the module is kept in a predictable or calculated location relative to the level extrusion.

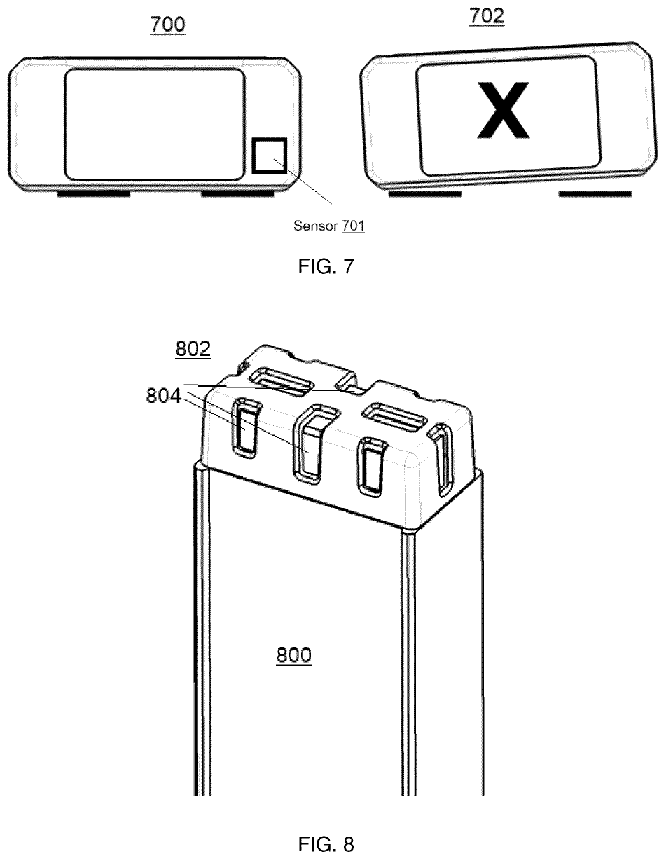

In an alternative embodiment shown in FIG. 7, the level module includes one or more secondary sensor(s) 701 positioned within the module to detect and indicate (e.g., on the display) when module is aligned (relative to the level extrusion) correctly 700 or incorrectly 702. In the latter case, another alternative embodiment provides the controller in the module with a software-based compensation algorithm to generate control signal values that compensate (the displayed level) for any sensed differences with respect to the positioning.

The nature of the level display may vary, and that display may be analog (showing a line), digital (showing a number with a + or − indication), or combinations of the above. In a variant embodiment, the level module may be configured (e.g., with an audio signal processing circuit, and a speaker) to output an audible indication regarding the level measurement.

Although not required, in an alternative embodiment, the level extrusion is configured to support its own electronics, e.g., the power supply, microcontroller, and the like described above. In such case, and using either physical connections or radio frequency (RF) wireless (or Bluetooth), data and/or power may be shared between the level module and the level extrusion. As will be described below, and according to a further aspect of this disclosure, this data (e.g., control signaling) and power may be used to control sets of lighting elements positioned with the extrusion. Calibration data regarding information that is specific to the level extrusion may be stored locally on the level extrusion and then read by the level module as needed, e.g., in calculations and adjustments displayed to the user. Preferably, and once again when the extrusion is capable of receiving and storing data, the level module is also configured to write data to the level extrusion to facilitate control of the overall system.

Using network interfaces supported for data communication, the level module (and the level extrusion when capable) may share measurements with external devices, e.g, other tools, mobile devices, computers and the like, whether located locally or remotely.

As noted above with respect to FIG. 7 and the related description, the level module may be configured to indicate coupling interface consistency (i.e., the coupling of the level module to the level extrusion in which it is positioned), and it may also use this information for adjustments to information that is displayed to the user, or to display a warning to the user, e.g., that there is debris in the interface that is interfering with the coupling. More generally, the module is configurable to check against a predicted location (within the extrusion) versus its actual location and to output to the user (e.g., on the display) that it is (or is not) mounted correctly, as the case may be. Further, the module is configured to read calibration/position data (i.e., where the module should be location/position-wise, and what it should compensate for) based on data that is stored or accesssible by electronics (RFID or otherwise) in the extrusion. Any calibration differences between the module and the extrusion can then be compensated to ensure that the module readings are correct.

The level module also may contain illumination features or elements to indicate direction of travel to target a specific measurement angle.

In another embodiment, both the level module and the extrusion include electronic components (such as described above), such that that the module couples with the extrusion not only mechanically, but also electronically (physically or wirelessly) to share power and data back and forth as needed.

Illuminated elements to indicate movement direction

Often, knowing what direction a level (or adjacent surface) needs to move in order to hit (obtain) a desired location can be a time- and thought-intensive process. Levels sometimes need to be taken across more than one axis, further increasing the complexity. According to this disclosure, a set of one or more lighting elements are used to indicate to the user which direction a level needs to be moved in order to target a certain level. In this aspect, color transitions, lighting strobing frequencies, or other lighting configurations, are used to indicate to a user which direction, in multiple axes, or which way a user needs to move to obtain a desired reading (typically, a level). These one or more illuminated elements comprise lighting elements, such as individual LEDs, LED strips, individual light bulbs, fiber-coupled LEDs, LCDs, and combinations. The lighting elements are configured to be positioned in any portion of the level extrusion, although as described below (and depicted in FIGS. 8-10) a preferred position is within one or more endcaps. Typically, the lights may be a variety of colors. In an alternative embodiment, the illuminated elements are positioned within or along a given length of the level extrusion body. In still another embodiment, the illuminated elements are located within the level module itself.

In addition to color, the control elements (electronics) within the lighting system may provide flashing lights, or changes to the frequency of the lights (varying frequencies) to indicate distance from a target level (or other position). The lights may be in discrete locations or be configured as a continual transition along a strip/gradient. The light color may be controlled to correlate to a direction that the user should move to target a specific angle (to obtain a level orientation) or other desired measurement. Further, the lights may indicate movement(s) that may be necessary in one or more axes in order to target a set of measurements or target. Tolerance as it correlates to color changing may be preset or adjusted by the user to map color transitions to specific tolerances of angle. The lighting elements may themselves be removable or integrated into the level. If removable, the elements (e.g., an end cap) may also be configured to fit over existing levels, thereby allowing the user a retrofit option with respect to the existing level. Further, the lighting elements may be used in conjunction with an analog or digital-based level. The lighting elements may also contain their own sensor(s) to indicate direction of rotation. The lighting elements communicate with internal or external devices to receive input information, as well as data on which should be displayed, or otherwise indicated, to the user. According to a further feature, control over the lighting elements is configurable, and it may be carried out by the end user directly, or in an automated manner via supplied parameter(s) (or control signals). For example, there may be a given parameter used to define the behavior of a specific lighting element configuration, such as color, frequency of illumination, and so forth, and a parameter may be supplied by internal electronics within the system or by an external control source (e.g., a computing system configured for wireless communications with the level system) that provides the parameter remotely.

In a typical embodiment, and as described above, the one or more illuminated elements are controlled by suitable electronics within the level extrusion or the level module, as the case may be. A representative control system is a microcontroller that is programmed to provide the desired functions, with control sgnaling provided to the individual elements via a communications protocol (e.g., DMX).

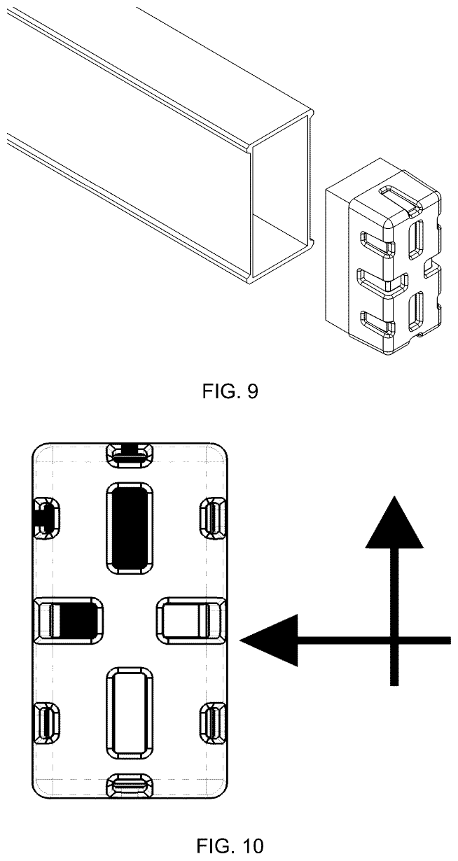

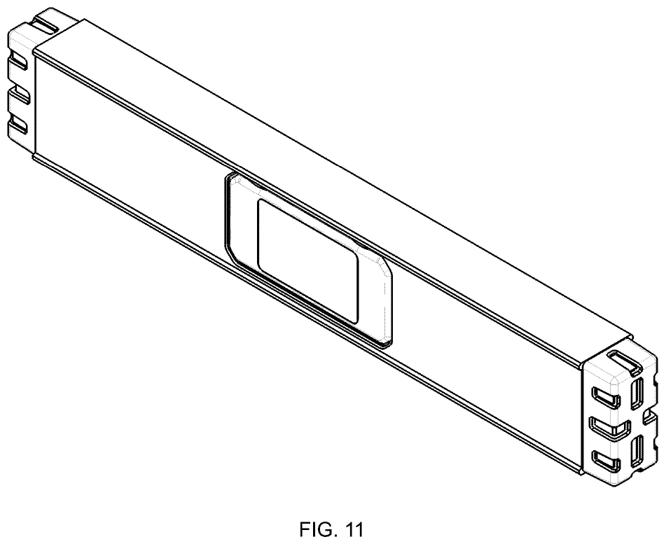

FIG. 8 depicts a typical implementation of the lighting elements. In this embodiment, the level extrusion 800 has the lighting elements supported in an endcap 802. The lighting elements 804 provide a combination of discrete lights and colors to indicate rotation direction. The endcap may be removable, such as depicted in FIG. 9. FIG. 10 depicts how the lighting elements are controlled to show the user what direction the extrusion body needs to be moved to obtain a desired location/reading. FIG. 11 depicts the endcap direction information (provided by the lighting elements) may correlate to level indicators elsewhere on the body and indicate direction or magnitude of travel needed.

The lighting elements may be configured as integrated components of the level system, or they may be configured as add-on elements for a retrofitted solution.

The lighting elements may be configured for use with the level system whether the separate level module/level extrusion arrangement is used.

Having described our invention, what we now claim is set forth below.

1. A level system, comprising:
a level module comprising a sensor, a display, and control elements configured to provide level indications on the display based on data collected by the sensor; and
at least one level extrusion, the level extrusion comprising a structural arrangement configured to independently receive and retain the level module, the level extrusion having a set of one or more illumination elements.

2. The level system as described in claim 1 wherein the set of one or more illumination elements are configured within an endcap of the level extrusion.

3. The level system as described in claim 1 wherein the set of one or moreo illumination elements are selectively controlled to provide one or more visual lighting cues.

4. The level system as described in claim 3 wherein a visual cue provides a movement direction.

5. The level system as described in claim 3 wherein a visual cue is one of: a color, a color transition, a set of different colors, illumination of a given light frequency, and a light strobe.

6. The level system as described in claim 1 wherein the set of one or more illumination elements comprise one of: an LED, an LED strip, and a discrete illumination bulb or fixture.

7. The level system as described in claim 1 wherein the set of one or more illumination elements is powered by the control elements in the level module.

8. The level system as described in claim 1 wherein the level extrusioin comprises a pair of endcaps, and each endcap comprises the set of one or more illumination elements.

9. A level, comprising:
an extrusion configured to be positioned on a surface and to provide a level indication, wherein the extrusion comprises a structural member having at least one cap positioned at an end thereof;
at least one lighting element configured in the at least one cap; and
a control element responsive e to a position or orientation of the extrusion relative to the surface to selectively control the at least one lighting element to output a visual cue, the visual cue providing an visual indication of a direction of movement to facilitate a level determination.

10. The level as described in claim 9, further including a level module configured to coupled within an opening in the extrusion, the level module including at least one display on which the level indication is output.

11. The level as described in claim 9, wherein the at least one lighting element includes a light emitting diode (LED).
